(19) United States
(12) Patent Application Publication
(10) Pub. No.: US 2021/0403348 A1
(43) Pub. Date: Dec. 30, 2021

(54) ELECTROLYSIS METHOD AND DEVICE FOR SPAS AND POOLS

(71) Applicant: Waterdiam FRANCE, Franken (FR)

(72) Inventor: Laurent Pupunat, Delémont (CH)

(21) Appl. No.: 16/646,535

(22) PCT Filed: Feb. 28, 2018
(86) PCT No.: PCT/IB2018/000315

§ 371 Date: Mar. 11, 2020

(51) Int. Cl. C02F 1/461; C02F 1/467

(52) U.S. Cl. CPC C02F 1/46109; C02F 2103/42; C02F 1/467

(57) ABSTRACT

The invention relates to a easily adaptable or DIY installation water purification device on existing any existing spa or pool, said purification device comprising an electrolysis module equipped with a particular boron-doped diamond electrode on silicum substrate. The inventions also relates to a method to purify water on spa or pools using a water purification device comprising said particular boron-doped diamond electrode present on the elecrolysis module.

The invention relates to a device used to clean water from spas and pools, where said device is a purification device comprising an electrolysis module comprising boron-doped diamond electrodes and adaptive electronic board which is an adaptable and DIY also known as do it yourself device. This invention is aimed to avoid any additional chemical use.

### BACKGROUND

Personal or public spas or pools are now commonly present in houses nowadays. Those installation require a minimum of maintenance to work efficiently and to keep the water clean and safe for people using them. The main problem encountered by owners is to be sure that the water is not polluted or comprises bacteria and/or fungus, very often transferred to the water from the skin of the users or contained in the water itself, or by polluted air interfacing with the water.

To solve this issue, regular use of agressive biocidal and fungicidal chemicals to clean the water is mandatory, especially chlorine derivatives. However such chemicals are not neutral when added to the water and they can be aggressive to bodily tissues and skin. A good example is for instance a burning sensation in the eyes one can feel it when swimming in a public or private pool without glasses.

Chemicals added on the water circuitry of spas or pools require qualified personnel to use them, and the chemicals should be handled with care. Chemical have drawbacks, as they can generate allergies or irritate the skin as well.

For example in US20030141202 it is described a method and apparatus for purging and desinfecting water. The invention discloses the use of an alkaline electrolyte solution that is electrolyzed by a diaphragm-less electrolyzer to provide electrolytic water as purging and disinfecting water. The alkaline electrolyte solution is a mixture of at least one alkaline electrolyte selected from caustic sodium carbonate, caustic potassium carbonate, phosphorous sodium carbonate and sodium hypochlorite, and at least one neutral salt selected from sodium chloride, potassium chloride, sodium bromide and potassium bromide.

The purging and disinfecting water is added to a water circulatory system. The result is that contaminants and noxious chemicals in the circulatory system are oxidation decomposed to thereby purge the circulating water, and noxious microorganisms such as germs, yeasts, fungi, and viruses, growing in the water circulatory system and causing degradation of water or development of slime are disinfected and thereby purged from the water circulatory system. The purging and desinfecting method can be carried out in a simple manner with minimum cost.

Despite the purging and desinfecting method can be carried easily with a minimum of cost, using caustic alkaline compounds is not necessarily safe.

In US2010351604 it is disclosed a method of sanitizing water contained in a spa, which comprises installing a chlorine generating cell including a diamond electrode in a filter compartment of the spa, employing a resin-filled calcium remover bag to reduce the hardness of the water, adding salt to the water; and operating the chlorine generating cell to generate chlorine and other sanitizing agents for sanitizing the water.

Although the method is efficient by using electrolysis it requires addition of salt to the water and a specific installation with a filter compartment which need a certain level of maintenance and specialist to install said device. Based on users testimonies accessible on Internet the use of additional chemicals is always needed to ensure water disinfection.

The drawbacks created by the use of chemicals and the maintenance of such systems, impel to find alternative systems or methods to clean the water used in spas or pools, with a minimum of maintenance need and do not require the use of chemicals which could be over the time harmful to people and do not then offer a real innovative performance.

### SUMMARY OF THE INVENTION

It has been suprisingly found that the drawbacks of the cited prior art are solvent by using a water purification device comprises at least two boron-doped diamond electrode coated on a silicon substrate, said diamond electrode providing a contact area that is comprised between 50 and 100 cm2, preferably 60 and 80 cm2, more preferably about 70 cm2.

In preferred embodiment said water purification device is easily adaptable to an existing purification system.

The operating voltage of the electrode present in the water purification device is comprised between −1V and −2V on cathodic polarization and between +2V and +4V on anodic polarization.

In a preferred embodiment said electrode comprises a boron doped diamond layer which is coated on a silicon substrate.

The electrode present in the water purification devices can adopt various forms such as a circular, square, triangular rectangular or star-shaped transversal cross-section in a plane perpendicular to a longitudinal direction of said electrode.

In a preferred embodiment the thickness of the boron doped diamond layer is comprised between 1 μm and 9 μm, preferably 1 and 4 μm, more preferably 1 and 3 μm.

The resistivity of the silicon substrate in the water purification device is comprised between 50 to 200 mOhm.cm, preferably 50 to 150 mOhm.cm.

Said water purification device comprises the electrolysis module containing the boron-doped diamond electrode deposited on a substrate; said electrolysis module is crossed by one hydraulic or water flow and by an electric flow.

In a preferred embodiment said water purification device according to any of the hydraulic or water flow sensor.

Another aspect of the invention is a method to purify bathing water in spas or pools without fungicidal or biocidal chemical additives, comprises the steps of:

i) Installing a purification device in a water filtration circuit of a spa or pool;

ii) Circulating bathing water contained in said spa or pool in said filtration circuit by a filtration system and/or a pump such that said electrode is in permanent contact with water in said spa or pool filtration circuit

iii) Applying an electric current to said electrode to electrolyze the water circulated over said electrode.

In a preferred embodiment when applying the method of purify bathing according to the invention is to maintain the pH of the water present in said spas or pools between 6 and 8.

In the method according to the invention is it is important that the temperature of the water is maintained between _35° C. and 45° C.

In the method according to the invention the water is circulated continuously in said filtration circuit and the electrode is powered during at least 30 min to one hour.

In a preferred embodiment in the method according to the invention the electrode is powered at regular intervals.

In a preferred embodiment in the method according to the invention the electrode is powered 4 to 12 times per day.

In the method according to the present invention, the water does not contain any chemical additives, except a conductivity salt such as NaCl mandatory for the electrolysis to take place. Said conductivity salt is present at the concentration of 0.2 to 2 g per Liter, preferably from 0.5 to 1 g per Liter.

### BRIEF DESCRIPTION OF THE DRAWINGS

and Features of the device and method of the invention will become apparent, from the following detailed description of an embodiment of the invention, in reference to the accompanying drawings. The drawings are merely representative and are not intended to limit the scope of the claims.

FIG. 1a illustrates an installation set-up for the water purification device of the invention in an existing pool having a filtration system;

FIG. 1b illustrates inserted corresponding installation set-up in an existing spa system;

FIG. 2a shows an electrolysis module comprising two boron-doped diamond electrodes forming parts of the water purification device according to the invention;

FIG. 2b shows a power supply module or box;

FIG. 3a illustrates a hydraulic or water flow sensor in connection with an electrolysis module;

FIG. 3b illustrates an earthing apparatus for the water of the spa or pool;

FIG. 4 illustrates the operating windows comparison between a boron-doped diamond electrode vs a platinum electrode, where the abscissa representing the voltage vs NHE (normal hydrogen electrode) and the ordinate the intensity (A/cm²) in H₂SO₄ 1M;

### DETAILED DESCRIPTION

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

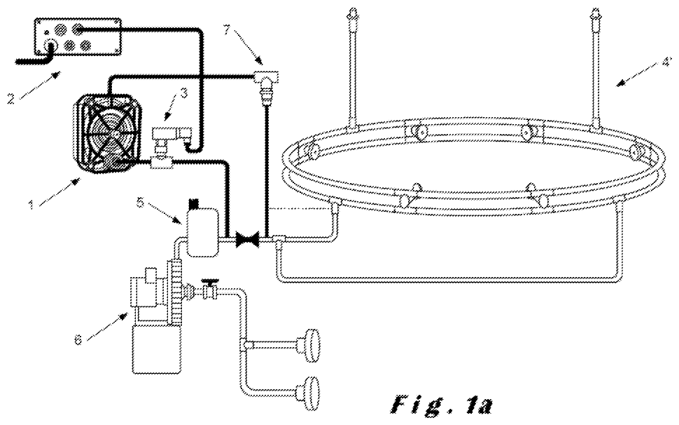

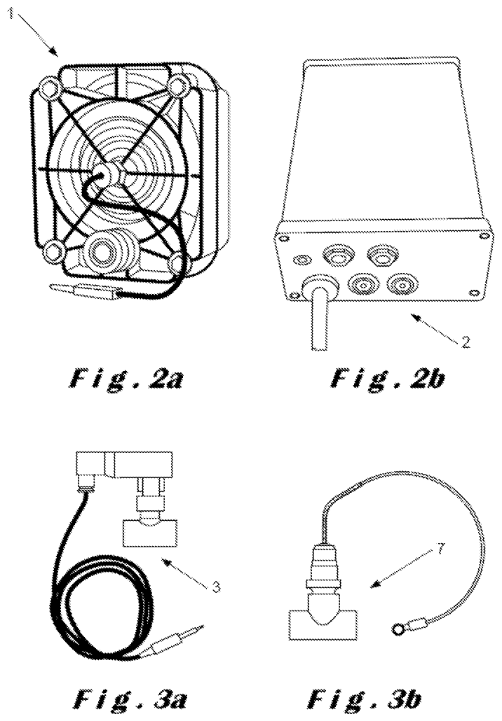

FIGS. 1a and 1b show the benefit of a water purification device according to the present invention. From an existing spa 4 or pool system with its own water circuit 4′, it is very easy to adapt a water purification device according to the invention, comprising a power supply module or box 2 in connection with at least one electrolysis module 1, which comprises at least two boron-doped diamond electrode deposited on a silicon substrate. The water purification device also comprises a hydraulic or water flow sensor 3 shown in FIG. 3a in connection with the electrolysis module and an earthing apparatus 7 (shown in FIG. 3b) to electrically connect the water of the spa or pool to the ground directly before or after the water has been circulated in the electrolysis module 1.

One advantage of the present invention is that the water purification device proposed is made of simple and inexpensive elements easy to adapt and install in existing spa or pool systems.

As highlighted in FIGS. 1a and 1b, the water purification device of the invention may be connected to an existing spa 4 or pool system 4′. Said spa 4 or pool system 4′ usually comprises water pipes or tubes forming a hydraulic circuit for circulating the water of said spa or spool in a closed loop. As represented in FIGS. 1a and 1b, such existing spa 4 or pool system 4′ further comprises a filtration system 6 and a heater 5 integrated in the hydraulic circuit in order to periodically or permanently filter and the water and keep it at the correct temperature. Said filtration system 6 extracts the dust and the biological material present or generated in the water through normal usage of the spa or the pool.

These classical systems usually require usage of chemical compounds such as chlorine as cleaning and purifying agents in the water on a regular basis, for example in pill, liquid or powder form, to remove or destroy fungus or bacteria present in water. Other known chemicals such as Trichloro isocyanure or PHMB for polyhexamethyleme biguanide can be used as well.

Adding such chemicals can be detrimental to the safety and comfort of users as, despite the presence of a filtering system, they can cause allergies or skin and tissues irritation of users.

The water purification system according to the invention advantageously allow for effective cleaning and purification of the water of spas and pools without using any chlorinated additives or fungicides, thanks to electrolysis of the water of a spa or pool by means of boron-doped diamond electrodes, which produces into the water natural disinfecting agents, including active oxygen, and eliminates micro-organisms, fungi, urea and like faster than any chlorinated additive.

This provides an undeniable advantage over the use of chemical compounds to purify the water of spa or pool. The only requirement for the purification system and method of the invention to work effectively is the presence in the water of a spa or pool to be disinfected of conductivity salts such as NaCl, either naturally present or added in the water if required. Said conductivity salt is present at the concentration of 0.2 to 2 g per Liter, preferably from 0.5 to 1 g per Liter, which is probably the lowest content of NaCl or conductivity salt usually present on spa and pools. By avoiding any added chemical compounds, the drawbacks such as skin or eyes irritation disappear for users.

The working principles of the water purification device of the invention, which will be described further, allows for a long period of time (about 3 months) to keep the water clean in said spa and pool without changing it and therefore reduces the maintenance of the spa or pool (changing the water, draining the spa or spool, changing the filter . . . ).

In the water purification device of the invention there is at least one electrolysis module 1 comprising at least two boron-doped diamond electrodes coated on a substrate.

Said electrode(s) provides a contact area that is comprised between 50 and 100 cm², preferably 60 and 80, more preferably about 70 cm².

Said surface area as well as the diamond nature of the electrode(s) provides a double advantage over the existing spa or pool purification systems configurations found in the prior art.

The first advantage with said surface area of the electrode(s) is that the contact between the electrode and the water to be treated is optimal, thus said contact area allows to treat efficiently about 6 to 10 m³ of water per day with a reduced consumption of electricity during the purification process.

A second important advantage is the operating windows (meaning the electrical parameters for the power supply of the electrode(s)) of said particular boron-doped diamond electrode(s).

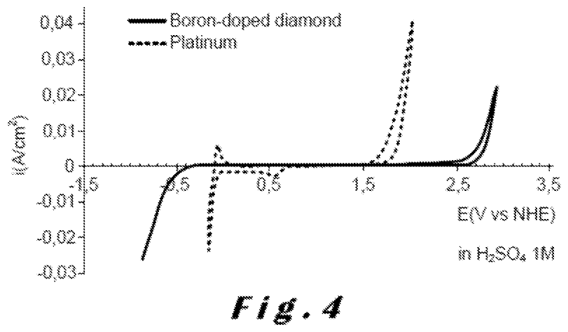

This aspect of the electrode(s) is very important as highlighted in FIG. 4 when comparing a classical platinum electrode used for electrolysis purpose with the one used in the purification device according to the invention.

The comparison of FIG. 4 shows that the particular diamond electrode of the water purification system of the invention, with its specific surface area, allows to work within a higher voltage window than the one of platinum.

It is very important as highlighted in FIG. 4 that the electrode according to the present invention is efficient when operating on a potential comprised between −1V and −2V on cathodic polarization and +2V and +4V on anodic polarization; in comparison the platinum electrode is only operatable efficiently between −0.3V on cathodic polarization and a maximum of +1.7V on anodic polarization.

This larger working window is of importance as shown in FIG. 4, because it has a direct impact on the electrolysis of the water according to the method of the invention.

While with platinum electrode we could have valuable chemical compounds generated to purify correctly when there is chemical additive added to the water generated such as O₃ from H₂O or O₂ from H₂O or Cl₂ from Cl⁻, the use of the electrode according to the present invention does no longer require any additives.

Without being bonded by theory, it seems that using said particular electrodes makes the water is own cleaning agent.

Therefore said particular diamond electrode(s) of the water purification system of the invention totally avoids the use of chemicals commonly used in spas or pools to clean them and is efficiently treating a large volume of water for a long period of time.

The boron-doped diamond electrode(s) could be according to the prior art deposited on various substrates such as metal or alloys, but the most convenient substrate found to be suitable for the application contemplated on spa or pool is a silicon substrate.

The thickness of said silicon substrate where the boron doped diamond layer is deposited on is about 1 μm and 9 μm, preferably 1 and 4 μm, preferably 1 and 3 μm.

Silicon is also preferred as a substrate for supporting the boron doped diamond layer as it cannot rust into water and a strong and efficient bond between silicon and the boron doped diamond layer can be obtained upon formation of the electrode(s).

The boron doped diamond layer is for example deposited by Chemical vapor deposition also known as CVD or by plasma assisted chemical vapor deposition process PACVD. Other examples of process for example, hot filament CVD (HFCVD); combustion flame CVD (CFCVD); arc jet plasma-assisted CVD (AJCVD); laser-assisted CVD (LCVD); and RF or microwave plasma-assisted CVD (RF or MW CVD) could be also contemplated.

The boron-doped diamond electrode(s) in the electrolysis module 1 of the purification system of the invention may have various shapes, and for example show a circular, square, triangular rectangular or star-shaped transversal cross-section in a plane perpendicular to a longitudinal direction of said electrode(s).

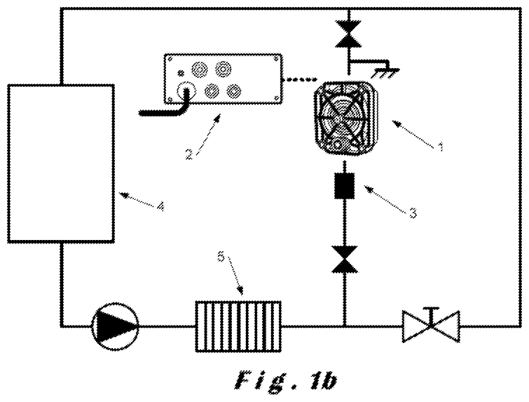

The electrolysis module 1 is open to a hydraulic or water flow in the water circuit of a spa or pool and connected to the electric power supply module 2. To work properly and not jeopardize the proper working conditions, the electrode(s) are supplied a direct current from the power supply module 2 as show in FIG. 2b. The power supply 2 is connected with the electrolysis module 1 providing a direct current to said electrode usually at 2.5 A. In case of required inversion of polarity such can be done automatically by the power supply module 2.

To work properly the electrolysis module 1 requires to be permanently bathed into water, and preferably that water is circulated over the electrodes by the filtration system 6 of the spa or pool. As shown in FIG. 3a a hydraulic or water flow sensor is preferably added in the water purification system shortly before a water inlet or after an outlet of the electrolysis module 1, that will measure the water flow passing therethrough.

According to FIGS. 1a and b, the electrolysis module 1 is connected in the existing water circuitry of the spa or pool via O-rings at least one inlet and at least one outlet of the electrolysis module 1. The water flow sensor is in connection with the power supply module 2, and if no water is flowing in the circuit, then the power supply module 2 shuts power supply to the electrolysis module 1.

Should the electrode(s) in the electrolysis module 1 not be bathed into water, then the power supply module 2 also detects the opening of the electrical circuit and thus shuts down power as well.

The water purification device according to the invention further comprises an earthing apparatus 7 (shown in FIG. 1a and FIG. 3b), for example in a T shaped electrode or else, configured to connect the water of the spa or pool system to ground, to avoid that any electrical short-circuit in the electrolysis module 1 or power supply module 2 may harm users present in the spa or pool.

The water purification device according to the present invention can advantageously work in an automatic mode or can be activated or deactivated on demand, manually or by using a remote controller system.

Another advantage of the present invention lies in the fact that the water purification device does not necessarily need permanent activation but can be activated periodically, i.e. at timely intervals, preferably but not necessarily regular intervals. It has been found that electrolyzing the water at regular intervals allows for the water to remain clean for a long period of time. Activating the electrolysis module between 4 to 12 times for at least one hour duration per day is sufficient to obtain clean water, for over 3 month to one year. In case of strong frequentation, the electrolysis module can be activated full time for up to one full day.

Another object of the present invention is a method to purify bathing water in spas or pools without fungicidal or biocidal chemical additives, wherein the method comprises the steps of:
Installing a water purification device according as described previously in an existing water filtration circuit of a spa or pool;
Circulating bathing water contained in said spa or pool in said filtration circuit by a filtration system and/or a pump such that the boron-doped diamond on silicon substrate electrode present in the electrolysis module 1 is in permanent contact with water in said spa or pool filtration circuit;
and then applying an electric current to said electrode to electrolyze the water circulating over said electrode.

As mentioned previously to enhance the capacity of the system to speed the water purification process or to treat efficiently a higher volume of water, it is possible to use at least one electrolysis module, just requiring to adapt accordingly the connection of the existing water circuit with the electrolysis module present with the water purification device.

It is important that the pH of the water should not be too much acid to promote water comfort, the ideal pH to use efficiently the water purification device is between 6 to 8.

It is also important to avoid having warm water on the purification device system; water maintained between 35° C. and 45° C., ideally 40° C. is the best temperature for using the water purification device.

Another advantage of the purification device according to the invention is the low level of maintenance on the electrodes present in the electrolysis module 1. A simple inversion of the polarity of said boron doped diamond electrodes will be required to clean them and is performed by the electronic card of the dedicated box.

Those skilled in the art will appreciate from the foregoing that various adaptations and modifications of the just described embodiments can be configured without departing from the scope and sprit of the invention. Therefore, it is to be understood that, within the scope of the appended claims, the invention may be practiced other than as specifically described herein.

1-20. (canceled)

21. A water purification device comprising at least two boron-doped diamond electrodes coated on a silicon substrate, said diamond electrodes providing a contact area of between about 50 and 100 cm².

22. The water purification device of claim 21, wherein said diamond electrodes have contact area of between about 60 and 80 cm².

23. The water purification device of claim 21, wherein said diamond electrodes have a contact area of about 70 cm².

24. The water purification device of claim 21, wherein the operating voltage of said electrodes is between −1V and −2V on cathodic polarization and between +2V and +4V on anodic polarization.

25. The water purification device of claim 21, wherein each electrode has a circular, square, triangular rectangular or star-shaped transversal cross-section in a plane perpendicular to a longitudinal direction of said electrode.

26. The water purification device of claim 21, wherein each electrode includes a boron doped diamond layer coated on a silicon substrate.

27. The water purification device of claim 26, wherein the thickness of the boron doped diamond layer is between 1 μm and 9 μm.

28. The water purification device of claim 26, wherein the thickness of the boron doped diamond layer is between 1 μm and 4 μm.

29. The water purification device of claim 21, wherein the resistivity of the silicon substrate is between 50 to 200 mOmh.cm.

30. The water purification device of claim 29, wherein the resistivity of the silicon substrate is between 50 to 150 mOmh.cm.

31. The water purification device of claim 21 further comprising an electrolysis module containing the boron-doped diamond electrodes, which is crossed by a hydraulic flow and by an electric flow.

32. The water purification device of claim 21 further comprising a hydraulic flow sensor.

33. A method to purify bathing water in spas or pools without fungicidal or biocidal chemical additives, the method comprising:
i) installing a purification device comprising a boron-doped diamond electrode coated on a silicon substate, said diamond electrode having an active surface area of between about 50 and 100 cm², the device installed in a water filtration circuit of a spa or pool;
ii) circulating bathing water contained in said spa or pool in said filtration circuit by a filtration system such that said electrode is in permanent contact with water in said filtration circuit.
iii) applying an electric current to said electrode to electrolyze the water circulated over said electrode.

34. The method of claim 33, wherein the pH of said water is maintained between 6 and 8.

35. The method of claim 33, wherein water is circulated continuously in said filtration circuit and the electrode is powered for a duration of at least 30 minutes.

36. The method of claim 35, wherein the electrode is powered in regular intervals.

37. The method of claim 36, wherein the electrode is powered 4 to 12 times per day.
